(19) United States
(12) Patent Application Publication
(10) Pub. No.: US 2018/0164497 A1
(43) Pub. Date: Jun. 14, 2018

(54) BACKLIGHT SOURCE, BACKLIGHT MODULE AND DISPLAY DEVICE

(71) Applicant: Wuhan China Star Optoelectronics Technology Co., Ltd., Wuhan, Hubei (CN)

(72) Inventor: Gege ZHOU, Shenzhen, Guangdong (CN)

(73) Assignee: Wuhan China Star Optoelectronics Technology Co., Ltd., Wuhan, Hubei (CN)

(21) Appl. No.: 15/112,506

(22) PCT Filed: Jun. 29, 2016
(86) PCT No.: PCT/CN2016/087675

§ 371 Date: Jul. 19, 2016

(30) Foreign Application Priority Data
Jun. 17, 2016 (CN) 201610431926.5

(51) Int. Cl. F21V 8/00

(52) U.S. Cl. CPC G02B 6/0083; G02B 6/0088; G02B 6/0068

(57) ABSTRACT

The present disclosure provides a backlight source and a backlight module at least including a plastic frame, a light guide plate and a backlight source, the backlight source is in the plastic frame and is arranged opposite to the incident surface of the light guide plate, the backlight source includes a circuit board and a plurality of light sources sequentially arranged on the surface of the circuit board, the opposite ends of each light source are provided with the solder feet for connecting the circuit board, and the two solder feet of each light source are arranged in a staggered manner and without overlapping part, with a gap between each two adjacent light sources, the solder feet of the two light sources formed the gap are arranged in a staggered manner in the gap. The present disclosure also discloses a display device.

### CROSS REFERENCE

The present disclosure claims the priority of No. 201610431926.5, entitled “backlight source, backlight module and display device”, filed on Jun. 17, 2016, the disclosure of which is incorporated herein by reference in its entirety.

### FIELD OF THE DISCLOSURE

The present disclosure relates to a liquid crystal display field, and more particularly to a backlight source, a backlight module and a display device.

### BACKGROUND OF THE DISCLOSURE

The liquid crystal display (LCD) has the advantages of body thin, low power, no radiation, etc., has been widely used, such as mobile phone, PDA, digital camera, computer screen or laptop screens, the conventional LCDs on the market are most of the backlit liquid crystal display device, the LCD includes a case, a liquid crystal panel arranged in the case and a backlight module arranged in the case.

The conventional backlight module includes a plastic frame, a back plate, a light guide plate arranged in the back plate and a backlight source arranged in the light guide plate, the backlight source includes a light bar circuit board and a LED wick arranged on the light bar circuit board, the placing form of the usually light bar light source is in an adjacent positive and negative way; this placing form is limited by the circuit board and the length of the light source to determine the number of the light sources, in order to enhance the brightness of the backlight is bound to increase the number of the light sources, and this structure will limit the number of the light sources.

### SUMMARY OF THE DISCLOSURE

The present disclosure provides a backlight source and a backlight module with sufficient light source to enhance the backlight brightness of the backlight module.

The present disclosure further provides a display device.

To achieve the above object, the embodiment of the present disclosure provides the following technical solutions:

The present disclosure provides a backlight source including a circuit board and a plurality of light sources sequentially arranged on the surface of the circuit board, the opposite ends of each light source are provided with solder feet for connecting the circuit board, and the two solder feet of each light source are arranged in a staggered manner and without overlapping part, with a gap between each two adjacent light sources, the solder feet of the two light sources formed the gap are arranged in a staggered manner in the gap.

Wherein, the solder feet of two ends of each light source are first solder feet and second feet, in the two adjacent light sources, the second solder foot of one end of one light source is avoided the first solder foot of one end of another light source.

Wherein, the electrode polarity of the first solder feet and the second solder feet of two ends of each light source are opposite.

The present disclosure provides a backlight module at least including a plastic frame, a light guide plate and a backlight source, the plastic frame is arranged around the peripheral edge of the light guide plate, the backlight source is in the plastic frame and is arranged opposite to the incident surface of the light guide plate, wherein, the backlight source includes a circuit board and a plurality of light sources sequentially arranged on the surface of the circuit board, the opposite ends of each light source are provided with solder feet for connecting the circuit board, and the two solder feet of each light source are arranged in a staggered manner and without overlapping part, with a gap between each two adjacent light sources, the solder feet of the two light sources formed the gap are arranged in a staggered manner in the gap.

Wherein, the solder feet of two ends of each light source are first solder feet and second feet, in the two adjacent light sources, the second solder foot of one end of one light source is avoided the first solder foot of one end of another light source and the position relative to the side of the first solder foot.

Wherein, the backlight module further includes a back plate, the plastic frame, the light guide plate and the backlight source are accommodated in the back plate.

Wherein, the backlight module further includes an optical film, the optical film is superimposed on the light guide plate.

Wherein, the backlight module further includes a double-sided adhesive, the optical film is superimposed on the light guide plate, the backlight source is fixed with the plastic frame and the optical film through the double-side adhesive.

The display device of the present disclosure provided includes the backlight module and the liquid crystal panel, the liquid crystal panel is arranged on the backlight module.

The solder feet of the light source of the backlight source of the backlight module of the present disclosure is arranged in a staggered manner, on the different lines and without overlapping part, so when the surface of the circuit board placing a plurality of light sources, the solder feet of the opposite ends of the two light source are staggered rather than sequentially connected, the occupied length direction is reduced, may increase the number of the light sources, thereby increasing the brightness of the backlight module while without increasing the volume of the backlight module.

### BRIEF DESCRIPTION OF THE DRAWINGS

In order to more clearly illustrate the technical solutions of the present disclosure, it will simple introduce the required figures in the embodiment, obviously, in the following description the drawings are only some embodiments of the present disclosure, those of ordinary skill in speaking, without creative efforts of the premise, you can also obtain other drawings based on these drawings.

FIG. 1 is a schematic diagram of the backlight source in the preferred embodiment of the present disclosure.

FIG. 2 is a sectional schematic of the backlight module of the present disclosure.

### DETAILED DESCRIPTION OF PREFERRED EMBODIMENTS

The present disclosure will now be combined with the implementation of the drawings, were a clear example of the technical solutions of the present disclosure, a complete description of.

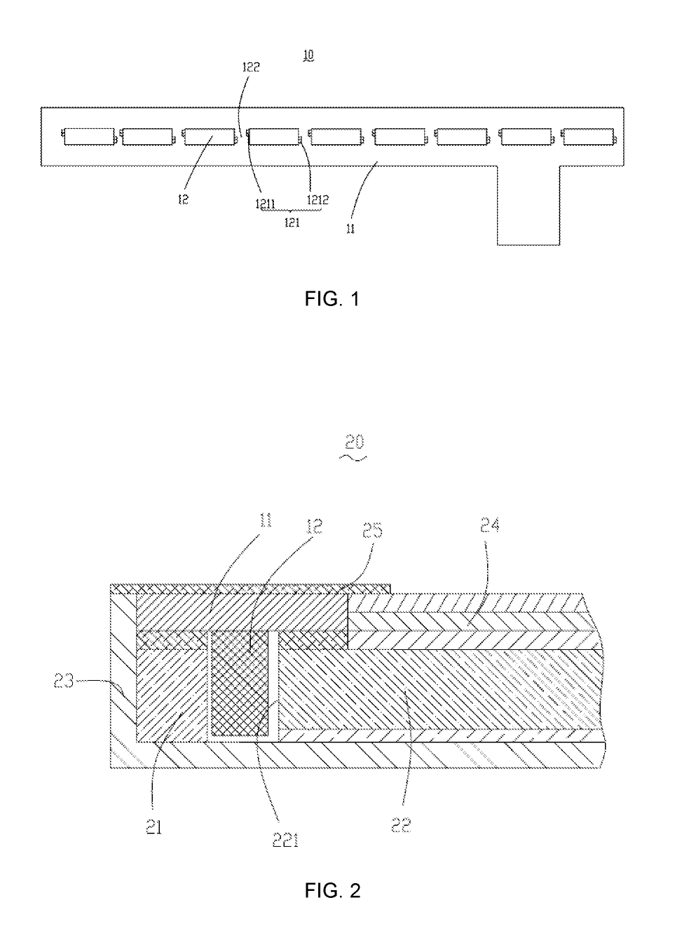

Please refer to FIG. 1 and FIG. 2, the present disclosure provides a backlight source 10 used in the backlight module 20 in the display device, wherein, the display device is a LCD, the display device includes a liquid crystal panel and a backlight module, the liquid crystal panel is fixed on the backlight module by the double-sided adhesive, etc., and is provided the light source through the backlight module.

As shown in FIG. 1, the backlight source 10 of the preferred embodiment of the present disclosure includes a circuit board 11 and a plurality of light sources 12. The plurality of light sources 12 are sequentially arranged on the surface of the circuit board 11, the opposite ends of each light source 12 are provided with solder feet 121 for connecting the circuit board 11, and the two solder feet of each light source 2 are arranged in a staggered manner and without overlapping part, with a gap 122 between each two adjacent light sources 12, the solder feet of the two light sources 12 formed the gap 122 are arranged in a staggered manner in the gap 122.

The light source 12 is a rectangular block, the plurality of light source 12 are arranged on the surface of the circuit board 11 along a straight line or a plurality of parallel lines, that was arranged in a rule matrix. In the present embodiment, the plurality of light sources 12 are arranged along a straight line, the ends of the plurality light sources 12 with solder feet are arranged in turn to the ends, and the ends of the plurality of light sources 12 with solder feet are arranged spaced to form the gap 122. The circuit board is a long strip of flexible circuit board.

The solder feet 121 of the two ends of the each light source 12 are the first solder feet 1211 and the second solder feet 1212, the first solder feet 1211 and the second solder feet 1212 are on the overlapping part of the two parallel lines, and where the straight lines of the first solder feet 1211 and the second solder feet 1212 are parallel the lines of the center of the plurality of light sources. In the two adjacent light sources 12, the second solder foot 1212 of the one end of the one light source 12 is avoided the first solder foot 1211 of the one end of another light source 12, and the position relative to the side of the first solder foot. The electrode polarity of the first solder feet 1211 and the second solder feet 1212 of two ends of each light source are opposite, i.e. one is positive and one is negative.

The solder feet of the light source in the backlight source are staggered arranged on the different straight lines and without overlapping part, so when the surface of the circuit board 11 placing a plurality of light sources 12, the two solder feet of the opposite ends of the light source are staggered rather than sequentially connected, the occupied length direction is reduced, the gap between two light sources may equivalent to the length of a solder foot, saving the occupied area of the circuit board, the number of the light source may be increased and the brightness may be improved while without increasing the area of the circuit board.

Please refer to FIG. 2, the present disclosure provides a backlight module 20 at least including a plastic frame 21, a light guide plate 22 and the backlight source 10, the plastic frame 21 is arranged around the peripheral edge of the light guide plate 22, the backlight source 10 is in the plastic frame 21 and is arranged opposite to the incident surface 221 of the light guide plate 22. Further, the backlight module 20 further includes a back plate 23 and an optical film 24, the plastic frame 21, the light guide plate 22 and the backlight source 10 are accommodated in the back plate 23. The optical film 24 is superimposed on the light emitting surface of the light guide plate 22. The backlight source 10 is between the incident surface of the light guide plate 22 and the plastic frame 21 and fixed with the plastic frame through the double-side adhesive.

The backlight module 20 further includes a double-side adhesive 25, the optical film 24 is superimposed on the light guide plate 22, and the backlight source 10 is fixed with the back plate 23 and the optical film 24 through the double-side adhesive.

The solder feet of the light source of the backlight source 10 are staggered arranged on the different straight lines and without overlapping part, so when the surface of the circuit board 11 placing a plurality of light sources 12, the solder feet of the opposite ends of the two light source are staggered rather than sequentially connected, the occupied length direction is reduced, the number of the light source may be increased, and the brightness of the backlight module may be improved while without increasing the area of the backlight module.

The above disclosed only a preferred embodiment of the present disclosure only, of course, not in order to define the scope of rights of the present disclosure, those of ordinary skill in achieving the above embodiments can be understood that all or part of the process, and in accordance with the disclosure of claim made identical change, which is still covered by the scope of the disclosure.

What is claimed is:

1. A backlight source, wherein, the backlight source comprises a circuit board and a plurality of light sources sequentially arranged on the surface of the circuit board, the opposite ends of each light source are provided with solder feet for connecting the circuit board, and the two solder feet of each light source are arranged in a staggered manner and without overlapping part, with a gap between each two adjacent light sources, the solder feet of the two light sources formed the gap are arranged in a staggered manner in the gap.

2. The backlight source according to claim 1, wherein, the solder feet of two ends of each light source are first solder feet and second feet, in the two adjacent light sources, the second solder foot of one end of one light source is avoided the first solder foot of one end of another light source.

3. The backlight source according to claim 2, wherein, the electrode polarity of the first solder feet and the second solder feet of two ends of each light source are opposite.

4. A backlight module at least comprises a plastic frame, a light guide plate and a backlight source, the plastic frame is arranged around the peripheral edge of the light guide plate, the backlight source is in the plastic frame and is arranged opposite to the incident surface of the light guide plate, wherein, the backlight source comprises a circuit board and a plurality of light sources sequentially arranged on the surface of the circuit board, the opposite ends of each light source are provided with solder feet for connecting the circuit board, and the two solder feet of each light source are arranged in a staggered manner and without overlapping part, with a gap between each two adjacent light sources, the solder feet of the two light sources formed the gap are arranged in a staggered manner in the gap.

5. The backlight module according to claim 4, wherein, the solder feet of two ends of each light source are first solder feet and second feet, in the two adjacent light sources, the second solder foot of one light source is avoided the first solder foot of another light source and the position relative to the side of the first solder foot.

6. The backlight module according to claim 4, wherein, the backlight module further comprises a back plate, the plastic frame, the light guide plate and the backlight source are accommodated in the back plate.

7. The backlight module according to claim 4, wherein, the backlight module further comprises an optical film, the optical film is superimposed on the light guide plate.

8. The backlight module according to claim 7, wherein, the backlight module further comprises a double-sided adhesive, the optical film is superimposed on the light guide plate, the backlight source is fixed with the plastic frame and the optical film through the double-side adhesive.

9. A display device, the display device comprises a backlight module and a liquid crystal panel, the backlight module at least comprises a plastic frame, a light guide plate and a backlight source, the plastic frame is arranged around the peripheral edge of the light guide plate, the backlight source is in the plastic frame and is arranged opposite to the incident surface of the light guide plate, wherein, the backlight source comprises a circuit board and a plurality of light sources sequentially arranged on the surface of the circuit board, the opposite ends of each light source are provided with solder feet for connecting the circuit board, and the two solder feet of each light source are arranged in a staggered manner and without overlapping part, with a gap between each two adjacent light sources, the solder feet of the two light sources formed the gap are arranged in a staggered manner in the gap, the liquid crystal panel is arranged on the backlight module.

10. The display device according to claim 9, wherein, the solder feet of two ends of each light source are first solder feet and second feet, in the two adjacent light sources, the second solder foot of one light source is avoided the first solder foot of another light source and the position relative to the side of the first solder foot.

11. The display device according to claim 9, wherein, the backlight module further comprises a back plate, the plastic frame, the light guide plate and the backlight source are accommodated in the back plate.

12. The display device according to claim 9, wherein, the backlight module further comprises an optical film, the optical film is superimposed on the light guide plate.

13. The display device according to claim 12, wherein, the backlight module further comprises a double-sided adhesive, the optical film is superimposed on the light guide plate, the backlight source is fixed with the plastic frame and the optical film through the double-side adhesive.
